(19) United States
(12) Patent Application Publication
(10) Pub. No.: US 2013/0071737 A1
(43) Pub. Date: Mar. 21, 2013

(54) LITHIUM IRON TITANIUM PHOSPHATE COMPOSITES FOR LITHIUM BATTERIES

(71) Applicants: Ilias Belharouak, Bolingbrook, IL (US); Gary M. Koenig, JR., Downers Grove, IL (US)

(72) Inventors: Ilias Belharouak, Bolingbrook, IL (US); Gary M. Koenig, JR., Downers Grove, IL (US)

(21) Appl. No.: 13/237,203

(22) Filed: Sep. 20, 2011

(51) Int. Cl. H01M 4/525; H01M 4/66; H01M 4/58; H01M 4/64; H01M 4/62; B82Y 30/00

(52) U.S. Cl. 429/211; 252/182.1; 977/742

(57) ABSTRACT

A compound with multiple integrated phases of general formula (1-x)LiFePO₄.LiₓTiₓ(PO₄)_{δ}, where 0<x≦0.3 and 1≦δ≦3, is prepared, and used in electrochemical devices.

### GOVERNMENT INTERESTS

The United States Government has rights in this invention pursuant to Contract No. DE-AC02-06CH11357 between the United States Government and UChicago Argonne, LLC, representing Argonne National Laboratory.

### FIELD

The present technology relates generally to composite materials for use as the active cathode component in a lithium-ion battery.

### BACKGROUND

Lithium-ion batteries are used extensively for consumer electronics applications and are increasingly being developed for larger scale energy storage applications; including hybrid, plug-in hybrid, and electric vehicles. The active cathode material used in such batteries, particularly in those for use in transportation applications, requires high power, high capacity, long cycle life, long calendar life, and excellent safety characteristics including thermal stability, low cost, and low toxicity. Current commercial electrode materials have difficulties providing all of these desired performance characteristics, and thus research has been conducted to search for new materials that can meet the demands of lithium-ion batteries for transportation applications.

The cathode of a lithium-ion battery is a composite of particles that reversibly intercalate lithium ions held together in a matrix by a polymeric binder. Typically, there are also carbon additives that improve the conductivity of the cathode. The most common commercial cathode material is LiCoO₂, although LiMn₂O₄ and LiFePO₄ are also produced in commercial quantities. One of the major drawbacks of LiCoO₂ is the relatively high cost and toxicity of cobalt, which makes this material challenging to implement in large scale transportation applications. LiFePO₄ is a promising cobalt-free alternative for the cathode in batteries for transportation applications. LiFePO₄ has an olivine structure, reversible capacities of up to ˜160 mA-h/g, high coloumbic and energy efficiency, and a charge/discharge voltage of ˜3.5 V (resulting in a total reversible energy storage of ˜560 W-h/kg). However, pure LiFePO₄ has poor conductivity and problems with cycling at reasonable charge/discharge rates.

### SUMMARY

In one aspect, a compound with multiple integrated phases of general formula (1-x)LiFePO₄.LiₓTiₓ(PO₄)₆ is provided, where 0<x≦0.3 and 1≦δ≦3, and where both the LiFePO₄ and the LiₓTiₓ(PO₄)₆ are electrochemically active components.

In another aspect, a composition is provided including a compound with multiple integrated phases of general formula (1-x)LiFePO₄.LiₓTiₓ(PO₄)_{δ} and a binder, where 0<x≦0.3 and 1≦δ≦3. In some embodiments, the binder includes poly(acrylonitrile), poly(vinylidene fluoride), polyvinyl alcohol, polyethylene, polystyrene, polyethylene oxide, polytetrafluoroethylene, polyimide, styrene butadiene rubber, poly(acrylonitrile) (PAN), poly(vinylidene fluoride) (PVDF), polyvinyl alcohol (PVA), polyethylene, polystyrene, polyethylene oxide, polytetrafluoroethylene (Teflon), polyimide, styrene butadiene rubber (SBR), carboxy methyl cellulose (CMC), gelatine, a copolymer of any two or more such polymers, or a blend of any two or more such polymers.

In another aspect, an electrode is provided including a compound with multiple integrated phases of general formula (1-x)LiFePO₄.LiₓTiₓ(PO₄)_{δ}, where 0<x≦0.3 and 1≦δ≦3; a binder; and a current collector. In some embodiments, the binder includes poly(acrylonitrile), poly(vinylidene fluoride), polyvinyl alcohol, polyethylene, polystyrene, polyethylene oxide, polytetrafluoroethylene, polyimide, styrene butadiene rubber, poly(acrylonitrile) (PAN), poly(vinylidene fluoride) (PVDF), polyvinyl alcohol (PVA), polyethylene, polystyrene, polyethylene oxide, polytetrafluoroethylene (Teflon), polyimide, styrene butadiene rubber (SBR), carboxy methyl cellulose (CMC), gelatine, a copolymer of any two or more such polymers, or a blend of any two or more such polymers. In any of the above embodiments of the electrode, the current collector includes carbon paper, aluminum, nickel, platinum, palladium, gold, silver, copper, iron, stainless steel, rhodium, manganese, vanadium, titanium, or tungsten. In any of the above embodiments of the electrode, the electrode also may optionally include a conductive filler. The conductive filler may include carbon nanotubes, fullerenes, carbon black, graphite, graphene, or other carbonaceous materials.

In another aspect, an electrochemical device is provided including a cathode including a compound with multiple integrated phases of general formula (1-x)LiFePO₄.LiₓTiₓ(PO₄)_{δ}, where 0<x≦0.3 and 1≦δ≦3. In some embodiments, the electrochemical device also includes a binder. In any of the above embodiments of the electrochemical device, the device also may include a current collector. In some embodiments, the device is a lithium ion battery.

In another aspect, a process is provided for preparing a compound of general formula LiFe₁₋ₓTiₓPO₄, wherein: 0<x≦0. The process includes milling a lithium source, an iron source, a titanium source, and a phosphate source at a molar ratio of 1:1-x:x:1 in a suitable suspending medium to form a mixture, and pyrolyzing the mixture. In one such embodiment, the lithium source includes lithium carbonate; the iron source includes iron oxalate dihydrate; the titanium source includes titanium oxysulfate; and the phosphate source includes ammonium dihydrogen phosphate.

The foregoing summary is illustrative only and is not intended to be in any way limiting. In addition to the illustrative aspects, embodiments and features described above, further aspects, embodiments and features will become apparent by reference to the following drawings and the detailed description.

### DESCRIPTION OF THE DRAWINGS

FIGS. 1A, 1B, 1C, and 1D are X-ray diffraction (XRD) patterns of LiFePO₄ with various amounts of Ti added to form (1-x)LiFePO₄.LiₓTiₓ(PO₄)_{δ} composite materials, according to the examples.

FIG. 2 is a charge/discharge cycling graph between 2.0 V and 4.0 V for a battery incorporating a (1-x)LiFePO₄.LiₓTiₓ(PO₄)_{δ} composite (x=0.05; δ=1≦δ≦3), according to the examples.

FIG. 3 is a charge/discharge cycling graph between 2.0 V and 4.0 V for a battery incorporating a (1-x)LiFePO₄.LiₓTiₓ(PO₄)_{δ} composite (x=0.1; δ=1≦δ≦3), according to the examples.

FIG. 4 is an enlarged view of the 2 charge/discharge cycles of FIG. 3, to highlight the low voltage (2.0 V to 3.0 V) plateau features, according to the examples.

FIG. 5 is a voltage versus time graph during the first 3 charge/discharge cycles of a battery incorporating a (1-x)LiFePO₄.LiₓTiₓ(PO₄)_{δ} composite (x=0.1; δ=1≦δ≦3) between 2.0 V and 4.0 V, according to the examples.

FIG. 6 is an enlargement of one region in FIG. 5 where the reversibility of the 3 plateaus in the low voltage (2.0 V to 3.0 V) region during charge and discharge can be clearly seen, according to the examples.

FIG. 7 is a graph of dQ/dV as a function of voltage calculated from the cycling of a battery incorporating (1-x)LiFePO₄.LiₓTiₓ(PO₄)_{δ} composite (x=0.1; δ=1≦δ≦3) between the voltages of 2.0 V and 4.0 V, according to the examples.

FIG. 8 is an enlargement of FIG. 7 to highlight the 3 reversible peaks in the dQ/dV between 2.0 V and 3.0 V, according to the examples.

FIG. 9 is a graph of the capacity during cycling at increasing rates (10, 50, 100, and 200 mA/g) for a (1-x)LiFePO₄.LiₓTiₓ(PO₄)_{δ} composite (x=0.1; δ=1≦δ≦3) battery, according to the examples.

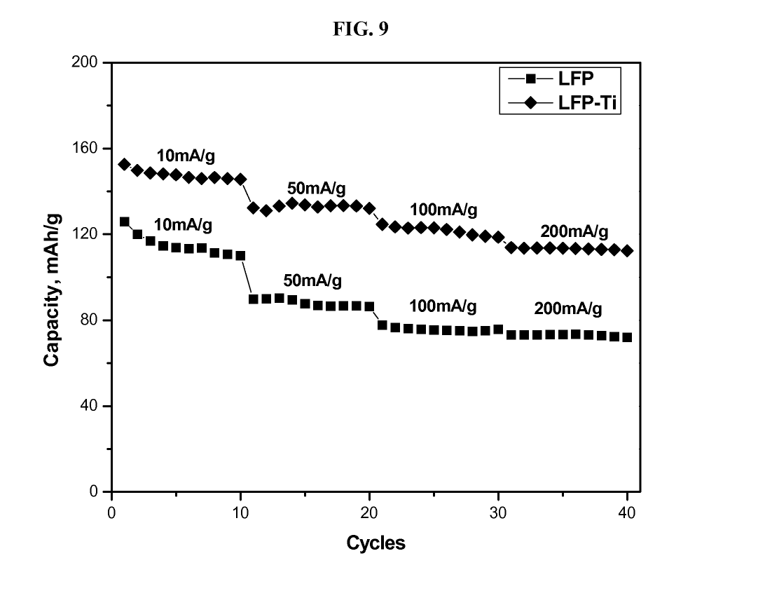

FIG. 10 is a graph of the capacity during the charge and discharge cycles of a battery incorporating a (1-x)LiFePO₄.LiₓTiₓ(PO₄)_{δ} composite (x=0.1; δ=1≦δ≦3) at different rates (10, 50, 100, and 200 mA/g), according to the examples.

FIG. 11 is a graph of the discharge curves during cycling at increasing rates (10, 50, 100, and 200 mA/g) between 2.0 V and 4.0 V for a battery incorporating a (1-x)LiFePO₄.LiₓTiₓ(PO₄)_{δ} composite (x=0.1; δ=1≦δ≦3), according to the examples.

FIG. 12 is a graph of the discharge curves during cycling of a battery incorporating a (1-x)LiFePO₄.LiₓTiₓ(PO₄)_{δ} composite (x=0.1; 1≦δ≦3) at increasing rates (10, 100, 500, and 1000 mA/g), according to the examples.

FIG. 13 is a graph of the discharge curves during cycling of a battery incorporating a (1-x)LiFePO₄.LiₓTiₓ(PO₄)_{δ} composite (x=0.1; 1≦δ≦3) at increasing rates (10, 100, 500, and 1000 mA/g), according to the examples.

FIG. 14 is a graph of the discharge capacity of batteries incorporating a (1-x)LiFePO₄.LiₓTiₓ(PO₄)_{δ} composite (x=0.1; 1≦δ≦3) during cycling, according to the examples.

FIG. 15 is a graph of the first charge/discharge cycle between 1.5 V and 3.5 V for a Li/LiTi₂(PO₄)₃ battery at a rate of 1 mA/g, according to the comparative example.

FIG. 16 shows the first charge/discharge cycle between 1.5 V and 3.5 V for a Li/TiP₂O₇ battery at a rate of 1 mA/g, according to the comparative example.

FIG. 17 shows the first charge/discharge cycle between 1.0 V and 3.5 V for a Li/LiTiO(PO₄) battery at a rate of 1 mA/g, according to the comparative example.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

The technology is described herein using several definitions, as set forth throughout the specification.

The use of the terms “a” and “an” and “the” and similar referents in the context of describing the elements (especially in the context of the following claims) are to be construed to cover both the singular and the plural, unless otherwise indicated herein or clearly contradicted by context.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

As used herein the phrase “multiple integrated phases” refers to more than one crystallographic phase being present at the within the material. The integrated phases are not simply a solid solution where the titanium would substitute for the iron within the olivine LiFePO₄ structure, or a mere mixture of LiFePO₄ and a lithium titanium phosphate species. Instead, a “multiple integrated phase” refers to the co-existence of a predominantly olivine phase LiFePO₄ material, and the segregation at the nanometer or micrometer scale of other titanium-containing phases, which may include but are not limited to the nasicon-type phase LiTi₂(PO₄)₃, the oxyphosphate LiTiOPO₄, and the pyrophosphate TiP₂O₇. These other phases may be crystalline or amorphous.

In general, the synthesis of a composite material, and the composite material are provided herein, where the composite material includes a titanium-containing LiFePO₄. Characterization and electrochemical analysis confirms that this composite material shows surprising improvements in the rate capability and capacity, when used as the cathode material in a lithium-ion battery, as compared to pure LiFePO₄. This improvement in performance is achieved without the addition of a carbon coating on the material.

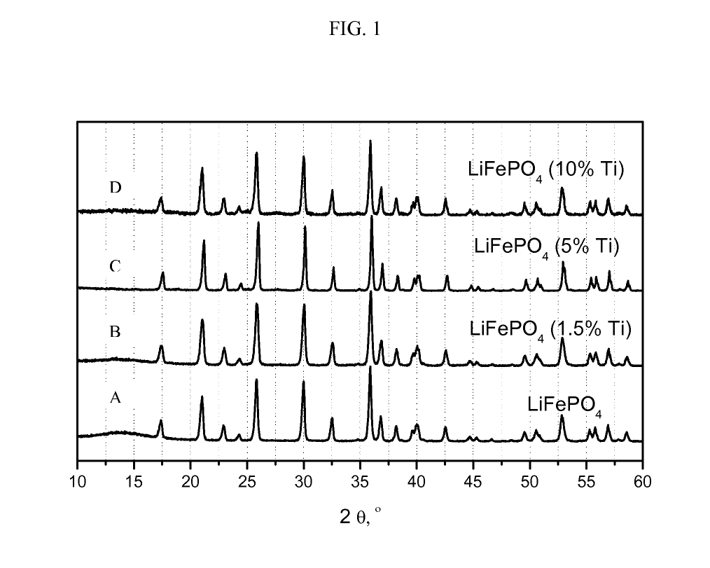

In one aspect, a titanium-containing composite of LiFePO₄ is provided having multiple integrated phases. The composition may be described as a “replacement” of iron content with that of titanium. For example, in the material, up to about 10 mol % of the iron may be replaced by titanium. This includes replacement of about 0.5 mol %, 1 mol %, 1.5 mol %, 2 mol %, 2.5 mol %, 5 mol %, 7.5 mol %, and 9.5 mol %, as well as the other values not expressly stated here. The composites have a similar structure to that of the pure LiFePO₄ as illustrated by the powder XRD patterns shown in FIG. 1. As shown, the XRD patterns are virtually identical for the pure LiFePO₄ as compared to those composites where up to at least about 10 mol % of the iron is replaced by titanium. The presence of the titanium, however, is confirmed by the electrochemical data, which exhibit additional electrochemical responses that are not consistent with pure LiFePO₄, but which are consistent with other phases including titanium. The addition of Ti during the synthesis of LiFePO₄ results in at least one new distinct material, and 3 new electrochemical features between 2.0 V and 3.0 V provide a signature for this new material in the composite. The titanium-containing composites of LiFePO₄ composites have improved rate capability when used as the cathode active material in a Li-ion battery, compared to pure LiFePO₄.

In one embodiment, the titanium-containing composite has general formula (I-x)LiFePO₄.LiₓTiₓ(PO₄)₆, where 0<x≦0.3 and 1≦δ≦3, and where both the LiFePO₄ and the LiₓTiₓ(PO₄)_{δ} are electrochemically active components. Such titanium-containing composites have multiple integrated phases. In one embodiment, the titanium-containing composite is 0.985.LiFePO₄.Li_{0.015}Ti_{0.015}(PO₄)_{δ}. In one embodiment, the titanium-containing composite is 0.95.LiFePO₄.Li_{0.05}Ti_{0.05}(PO₄)_{δ}. In one embodiment, the titanium-containing composite is 0.9.LiFePO₄.Li_{0.1}Ti_{0.1}(PO₄)_{δ}.

In another aspect, an electrode is provided that includes any of the above compositions. In one embodiment, the electrode includes a compound of general formula (1-x)LiFePO₄.LiₓTiₓ(PO₄)_{δ}, where 0<x≦0.3 and 1≦δ≦3; a binder; and a current collector. The electrodes may be prepared by mixing the composite material with the binder and applying it to the current collector. For example, the composite material may be mixed in a solvent with the binder to form a slurry that is then applied to the current collector. Illustrative binders include, but are not limited to, poly(acrylonitrile) (PAN), poly(vinylidene fluoride) (PVDF), polyvinyl alcohol (PVA), polyethylene, polystyrene, polyethylene oxide, polytetrafluoroethylene (Teflon), polyimide, styrene butadiene rubber (SBR), carboxy methyl cellulose (CMC), gelatine, a copolymer of any two or more such polymers, or a blend of any two or more such polymers. In some embodiments, the binder includes PVDF. In other embodiments, the binder includes polyimide. The solvent may be any suitable solvent to suspend the materials and solvate the binder. In one embodiment, the solvent is toluene, dimethylformamide, or N-methylpyrrolidone (NMP).

The current collector provides contact between the electroactive (composite) material and an external load to allow for the flow of electrons through a circuit to which the electrode is connected. The current collector may be a conductive material. Illustrative current collectors include, but are not limited to, carbon paper, aluminum, nickel, platinum, palladium, gold, silver, copper, iron, stainless steel, rhodium, manganese, vanadium, titanium, tungsten, or aluminum carbon coated or any carbon-coated metal. In some embodiments, the current collector is carbon paper, aluminum or copper.

Accordingly, in some embodiments, an electrode is provided that includes any of the composite materials above, a binder, and a current collector. In some embodiments, the binder includes poly(acrylonitrile), poly(vinylidene fluoride), polyvinyl alcohol, polyethylene, polystyrene, polyethylene oxide, polytetrafluoroethylene, polyimide, styrene butadiene rubber, carboxy methyl cellulose, gelatine, a copolymer of any two or more such polymers, or a blend of any two or more such polymers. In other embodiments, the current collector includes aluminum, nickel, platinum, palladium, gold, silver, copper, iron, stainless steel, rhodium, manganese, vanadium, titanium, tungsten, or carbon coated aluminum. In other embodiments, the current collector includes carbon paper, aluminum or copper.

The electrode may further include other additives and fillers such as, but not limited to, carbon nanotubes, fullerenes, carbon black, graphite, graphene, or other carbonaceous materials.

The electrodes, not including the current collector, may include from about 50 wt % to about 95 wt % of the active material (i.e. the titanium-containing composite material), and from about 5 wt % to about 50 wt % of the binder. Other additives may be optionally included at up to about 20 wt %. For example, in one embodiment, the electrode, not including the current collector, includes from about 60 wt % to about 90 wt % active material, from about 5 wt % to about 20 wt % binder, and from about 5 wt % to about 20 wt % of other additives, where the other additive is a carbon-containing material such as carbon black, carbon nanotubes, fullerenes, and the like. In another embodiment, the electrode, not including the current collector, includes from about 75 wt % to about 85 wt % active material, from about 5 wt % to about 15 wt % binder, and from about 5 wt % to about 10 wt % of other additives, where the other additive is a carbon-containing material such as carbon black, carbon nanotubes, fullerenes, and the like.

In another aspect, any of the above compounds, compositions, or electrodes may be incorporated into an electrochemical device. For example, the device may include a lithium ion battery. In some embodiments, the electrochemical device is a primary lithium battery, a secondary lithium battery, or a capacitor. In such embodiments, the electrochemical device may include a cathode that includes a compound of general formula (1-x)LiFePO₄.LiₓTiₓ(PO₄)_{δ}, where 0<x≦0.3 and 1≦δ≦3. Such electrochemical devices may also include, singly or together, a binder, a current collector, and the like. The electrochemical devices also include an anode, a non-aqueous electrolyte, and optionally, a porous separator. Suitable anodes include lithium, natural graphite, artificial graphite, graphene, Li₄Ti₅O₁₂, or silicon.

Suitable non-aqueous electrolytes include gelled and ungelled electrolytes. The electrolytes non-aqueous electrolytes include an alkali metal salt dissolved in a polar, aprotic solvent. The alkali metal salt is typically present at a concentration of from about 0.5 to about 2 molar and is typically a lithium salt. Exemplary lithium salts include LiCF₃CO₂, LiC₂F₅CO₂, LiClO₄, LiBF₄, LiAsF₆, LiPF₆, LiPF₂(C₂O₄)₂, LiPF₄(C₂O₄), LiCF₃SO₃, LiN(CF₃SO₂)₂, LiC(CF₃SO₂)₃, LiN(SO₂C₂F₅)₂), lithium alkyl fluorophosphates, lithium bis(oxalato)borate (LiBOB), LiBF₂(C₂O₄), Li₂B₁₂X₁₂₋ₙHₙ, Li₂B₁₀X_{10-n′}H_{n′}, and a mixture of any two or more such materials, where X is selected from OH, OCH₃, F, Cl, Br, or I, n is an integer from 0 to 12, and n′ is an integer from 0 to 10. Suitable polar, aprotic solvents for use in the non-aqueous electrolytes include, but not limited to, for example, siloxane, polysiloxane, ethyl acetate, propyl acetate, ethylene carbonate, propylene carbonate, dimethyl carbonate, diethyl carbonate, ethyl methyl carbonate, dimethyl ether, diethyl ether, methyl acetate, γ-butyrolactone, sulfolane, or a mixture of any two or more solvents. Suitable separators include, but are not limited to, those comprising a polyolefin, a polycarbonate, and the like. For example, the separator may include polypropylene or polyethylene.

In another aspect, a process is provided for the synthesis of a compound of general formula (1-x)LiFePO₄.LiₓTiₓ(PO₄)_{δ}, where 0<x≦0.3 and 1≦δ≦3. The process includes mixing an iron source, a lithium source, a phosphate source, and a titanium source at the appropriate stoichiometric ratios, and heating. The iron source may include, but is not limited to, iron oxalate dihydrate, iron nitrate, iron sulfate, iron acetate, iron carbonate, iron oxide, or iron phosphate. The phosphate source may include, but is not limited to, ammonium dihydrogen phosphate, diammonium hydrogen phosphate, ammonium phosphate, lithium dihydrogen phosphate, or phosphoric acid. The lithium source may include, but is not limited to, lithium carbonate, lithium hydroxide, lithium nitrate, lithium sulfate, lithium acetate, lithium dihydrogen phosphate, or lithium oxalate. The titanium source may include, but is not limited to, titanium oxysulfate, titanium sulfate, titanium chloride, or titanium oxide. The stoichiometries above may be used. Accordingly, the lithium source, the iron source, the phosphate source, and the titanium source may be mixed together at a molar ratio of 1:1-x:1:x. The powders of the source materials are then mixed (a suspending medium such as a solvent may optionally be used) and milled to achieve a consistent particle size. For example, the powders may be milled with a zirconia ball. Suitable solvents include, but are not limited to acetone, methylisobutylketone, ethanol, methanol, isopropanol, propanol, or butanol.

After mixing and milling to an appropriate size, the materials are pyrolyzed under an inert atmosphere. For example, the milled powders and solvent may be placed in a furnace that is exposed to nitrogen, helium, argon, or neon gas. The temperature of the heating is from about 300° C. to about 1000° C. In some embodiments, the temperature of the heating step is from 500° C. to 700° C. The heating is conducted until the process is driven to completion. This may take from 10 minutes to 20 hours, or more. In some embodiments, the heating is conducted for 10 minutes to several days. For example, the heating may be from 10 minutes to 48 hours. In some embodiments, the heating is from 1 hour to 24 hours. After pyrolysis (heating), the materials are again ground to a fine powder, the fine powder being used to fabricate cathodes for electrochemical cells, as described above.

The present technology, thus generally described, will be understood more readily by reference to the following examples, which are provided by way of illustration and are not intended to be limiting.

### EXAMPLES

General Procedures.

In the examples that follow, four compositions of final material are described: LiFePO₄, LiFePO₄—Ti (T±1.5 mol % based on Fe, equivalently denoted as 0.985.LiFePO₄.Li_{0.015}Ti_{0.015}(PO₄)_{δ}), LiFePO₄—Ti (T±5 mol % based on Fe, equivalently denoted as 0.95.LiFePO₄.Li_{0.05}Ti_{0.05}(PO₄)_{δ}), and LiFePO₄—Ti (Ti 10 mol % based on Fe, equivalently denoted as 0.9.LiFePO₄.Li_{0.1}Ti_{0.1}(PO₄)₅). As noted above, δ assumes a value from about 1 to about 3. All of the titanium-containing LiFePO₄ materials are composites that were synthesized by using stoichiometric substitutions of Fe at 1.5, 5, and 10 mol % with Ti. In a typical procedure, a target of 10 g of final material would be produced. Yields of the final desired material collected were routinely >95%. As an example, 10 g of 0.9.LiFePO₄.Li_{0.1}Ti_{0.1}(PO₄)_{δ} was synthesized by mixing Li₂CO₃ (2.3 g), FeC₂O₄.2H₂O (10.3 g), TiOSO₄ (1 g), and NH₄H₂PO₄ (7.3). The mixture was gently milled with zirconia balls and a small amount of acetone. The resulting well-mixed paste would be allowed to dry to a powder, and then packed into an alumina boat. The powder was then fired in a furnace with a surrounding argon atmosphere at 700° C. for 12 hours. After allowing the pyrolyzed material to cool to room temperature, the resulting 0.9.LiFePO₄.Li_{0.1}Ti_{0.1}(PO₄)_{δ} powder was ground by hand with a mortar and pestle into a fine powder. This fine powder is suitable for use as the active material in a lithium-ion battery cathode.

As described above, the Ti forms a secondary composite phase in addition to being substituted into the LiFePO₄ structure. For electrochemical characterization, the materials were used in an electrode including 80% active material, 10% acetylene black conductive additive, and 10% polyvinylenedifluoride binder coated on an aluminum current collector. The anode was lithium metal foil, the electrolyte was 1.2 M LiPF₆ dissolved in an ethyl carbonate:ethyl methyl carbonate (30%:70%) electrolyte with separator of porous polypropylene.

### Example 1

Powders were synthesized of LiFePO₄ (pure), 0.985.LiFePO₄.Li_{0.015}Ti_{0.015}(PO₄)_{δ}, 0.95.LiFePO₄.Li_{0.05}Ti_{0.05}(PO₄)_{δ}, and 0.9.LiFePO₄. Li_{0.1}Ti_{0.1}(PO₄)_{δ}. The X-ray diffraction (XRD) for the different powders is shown in FIG. 1. All materials have the olivine structure and can be indexed to the PMNB space group. Impurity phases were not discernable from visual inspection of the XRD patterns. Rietveld refinement was also carried out on the XRD patterns to determine the lattice parameters for the materials. The crystallographic parameters a, b, and c; and the cell volume (V) are provided in Table 1. As will be noted, the introduction of Ti does not have a significant influence on the crystallographic parameters of the pure LiFePO₄.

TABLE 1
Crystallographic Parameters For LiFePO₄ And Composites.

| | | LiFePO₄ | LiFePO₄ | LiFePO₄ |
|---|---|---|---|---|
| | LiFePO₄ | (1.5% Ti) | (5% Ti) | (10% Ti) |
| a | 10.314(9) | 10.311(1) | 10.324(6) | 10.307(5) |
| b | 5.999(4) | 5.996(4) | 6.003(2) | 5.993(4) |
| c | 4.689(1) | 4.686(4) | 4.691(6) | 4.681(9) |
| V | 290.18(1) | 289.74(9) | 290.78(3) | 289.23(4) |

### Example 2

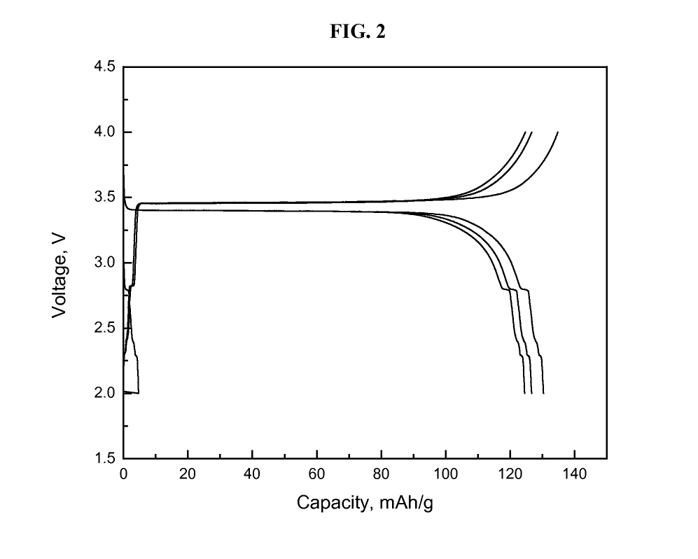

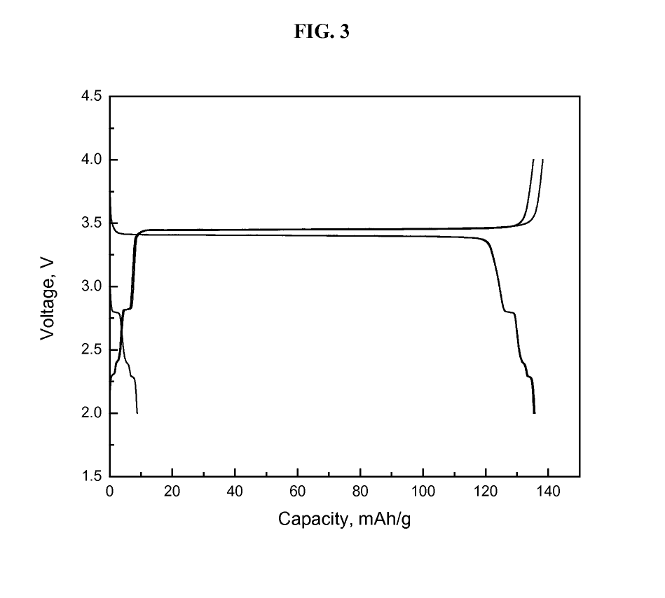

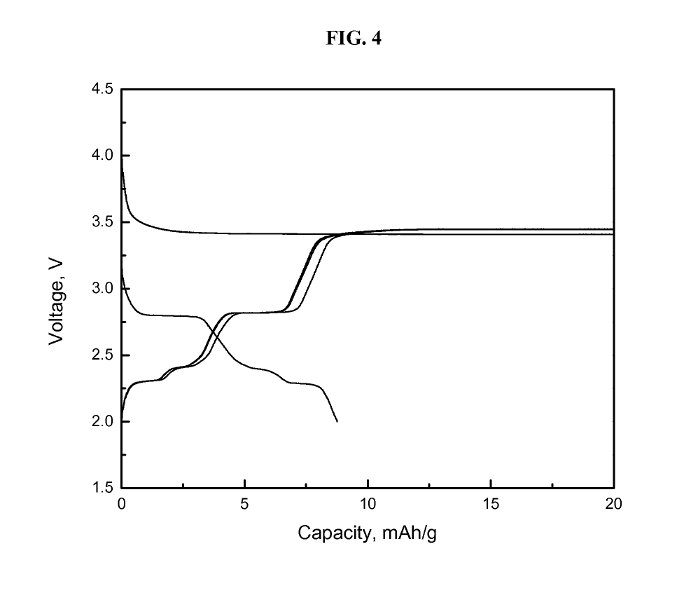

The four LiFePO₄ compositions described above were used as the active material in cathodes for lithium-ion batteries. All batteries were charged and discharged between 2.0 V and 4.0 V. The first 3 charge-discharge cycles for 0.95.LiFePO₄.Li_{0.05}Ti_{0.05}(PO₄)_{δ} are shown in FIG. 2 and the first 3 charge-discharge cycles for 0.9.LiFePO₄.Li_{0.1}Ti_{0.1}(PO₄)_{δ} are shown in FIG. 3. FIG. 4 is the same cell shown in FIG. 3, however the axes have been modified to highlight the capacity in the low voltage (2.0 V to 3.0 V) regions. The electrochemical profiles in FIGS. 2, 3, and 4 clearly have 3 reversible plateau features between 2.0 V and 3.0 V. These features are not present in pure LiFePO₄, and provide evidence of a composite material, although the second (or more) phases are not in sufficient concentration to be observed in XRD patterns (see FIG. 1).

### Example 3

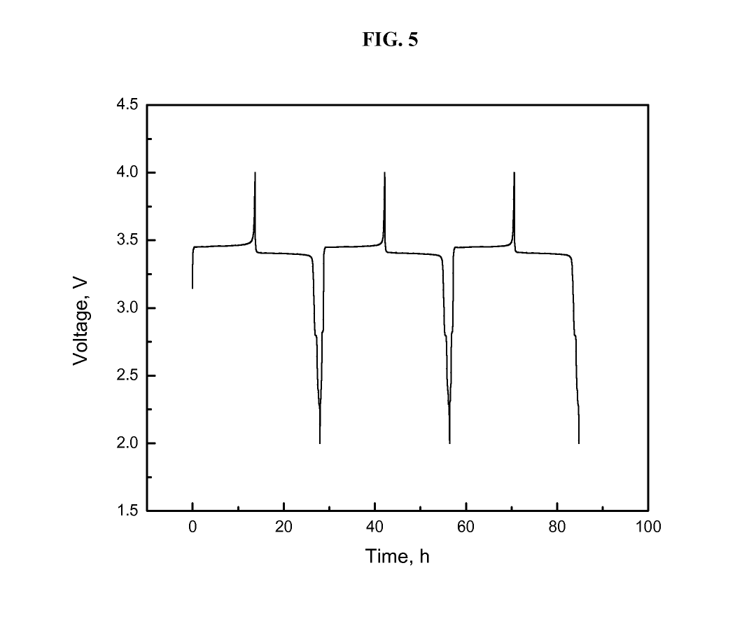

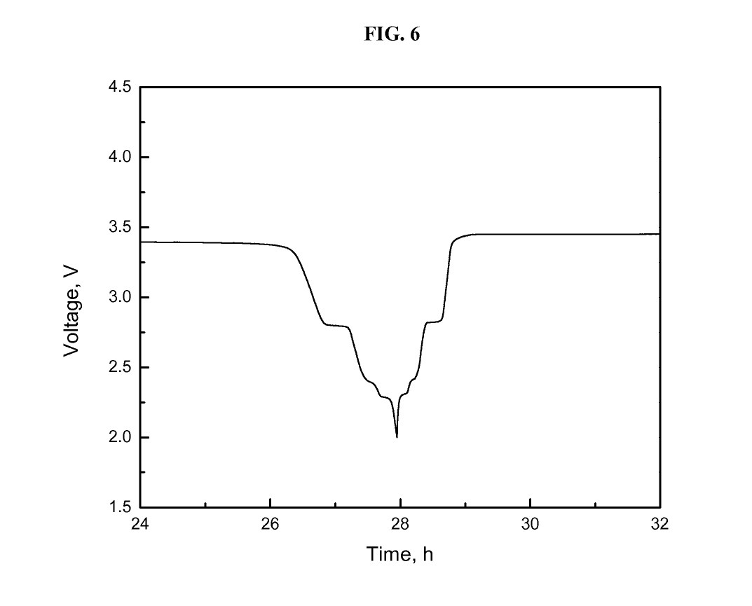

The voltage profile as a function of time during the charging/discharging of a Li/0.9.LiFePO₄.Li_{0.1}Ti_{0.1}(PO₄)_{δ} composite battery is shown in FIGS. 5 and 6. The profile exhibits three low voltage (2.0 V to 3.0 V) features for the composite material, in addition to the large reversible plateau at ˜3.4-3.5 V. The larger plateau is believed to be attributed to the dominant LiFePO₄ component.

### Example 4

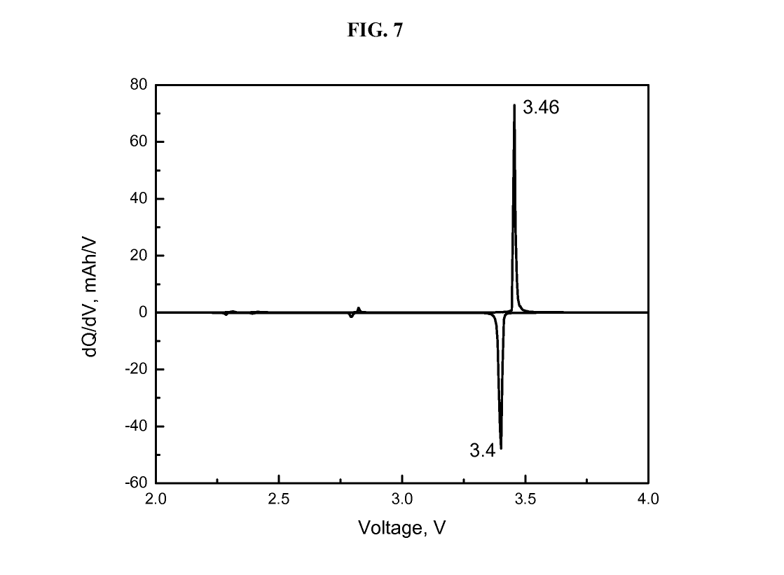

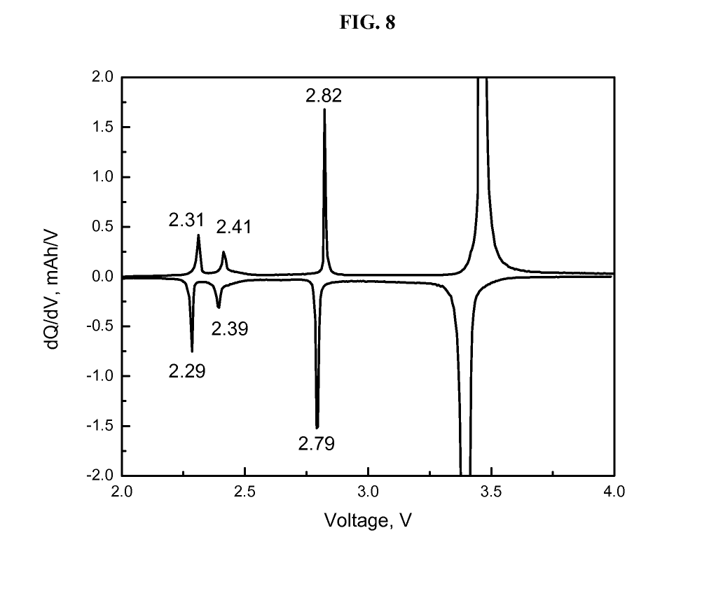

Peaks in the dQ/dV plots as a function of voltage for the 0.9.LiFePO₄.Li_{0.1}Ti_{0.1}(PO₄)_{δ} material cycled as the active cathode material in a lithium-ion battery are shown in FIGS. 7 and 8. The large reversible peaks at 3.46 V and 3.4 V are consistent with the dominant phase being LiFePO₄ (FIG. 7). The reversible low voltage features at 2.31 V, 2.41 V, and 2.82 V (during charge) and correspondingly at 2.29 V, 2.39 V, and 2.79 V (during discharge) provide evidence of additional phase(s) using this electrochemical characterization (FIG. 8).

### Example 5

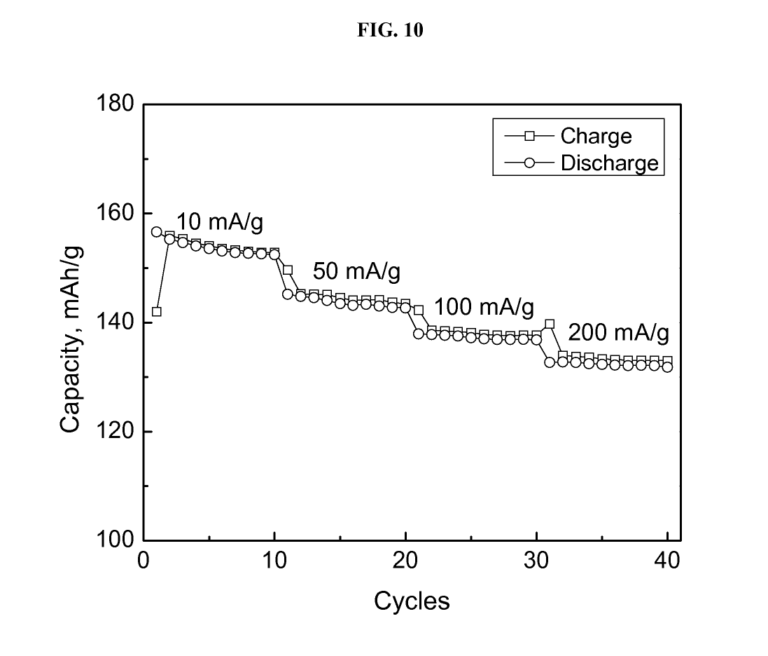

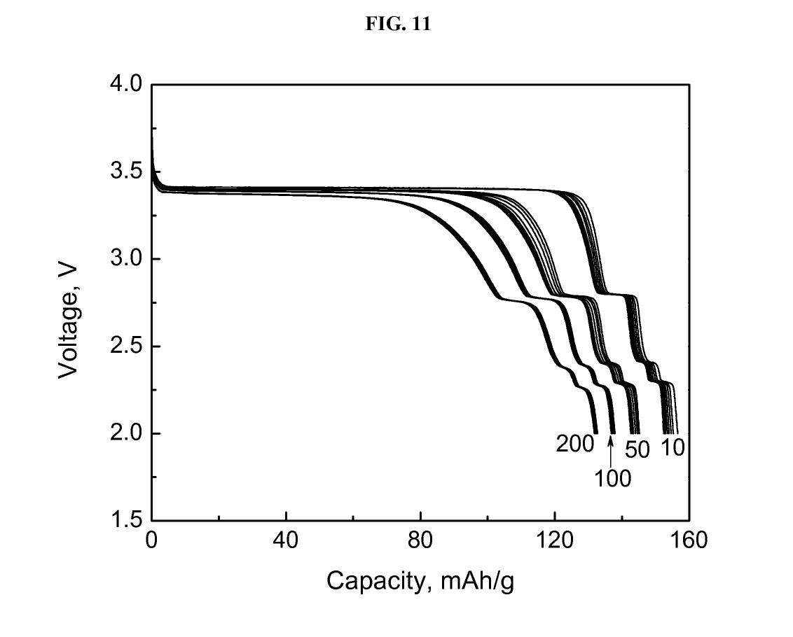

The electrochemical capacity of lithium-ion batteries with active cathode materials of 0.9.LiFePO₄.Li_{0.1}Ti_{0.1}(PO₄)_{δ} (LFP—Ti) and LiFePO₄ (LFP) were measured at increasing rates of 10, 50, 100, and 200 mA/g. The capacities during cycling at increasing rates are shown in FIG. 10. The 0.9.LiFePO₄.Li_{0.1}Ti_{0.1}(PO₄)_{δ} material had greater capacity than the LiFePO₄ material at every rate. The coloumbic efficiency of the 0.9.LiFePO₄.Li_{0.1}.Ti_{0.1}(PO₄)_{δ} was also nearly 100%. The capacity during charge and discharge of the 0.9.LiFePO₄.Li_{0.1}Ti_{0.1}(PO₄)_{δ} material is shown in FIG. 10. The full voltage and capacity profile during discharge at different rates for the 0.9.LiFePO₄.Li_{0.1}Ti_{0.1}(PO₄)_{δ} is shown in FIG. 11.

### Example 6

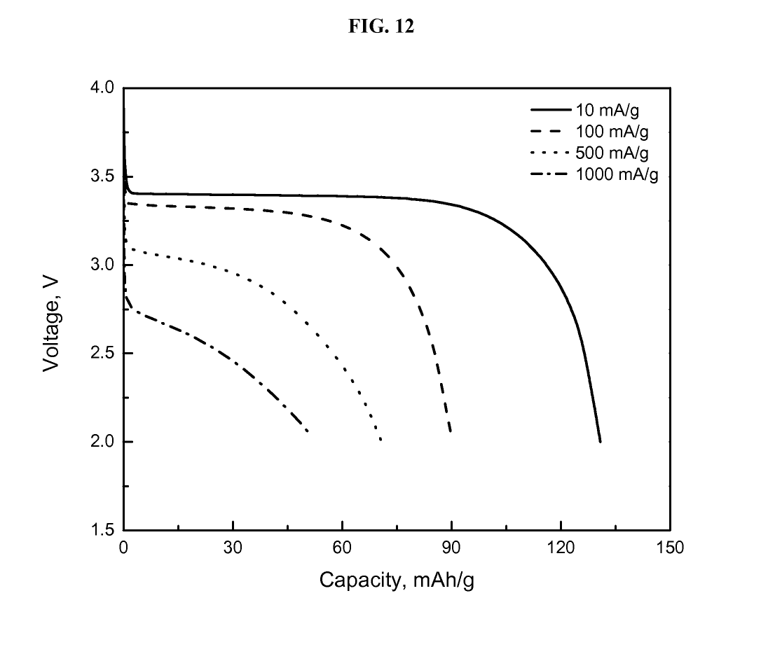

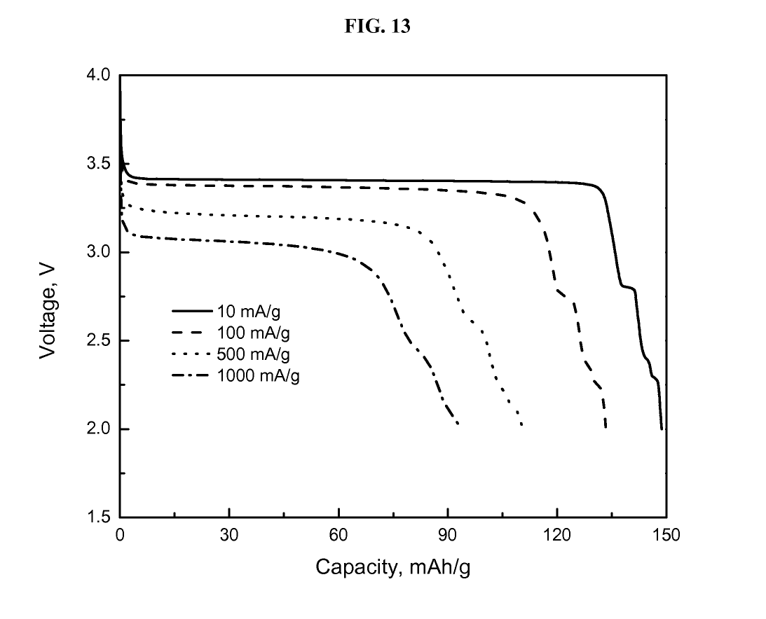

The discharge curves for LiFePO₄ at increasing rates is shown in FIG. 12. The discharge curves for the 0.9.LiFePO₄.Li_{0.1}Ti_{0.1}(PO₄)_{δ} composite material at the same rates are shown in FIG. 13. The 0.9.LiFePO₄.Li_{0.1}Ti_{0.1}(PO₄)_{δ} composite material has a greater capacity at every rate, and the 0.9.LiFePO₄.Li_{0.1}Ti_{0.1}(PO₄)_{δ} composite material is able to maintain the high voltage (>3.0 V) plateau for more of the capacity, resulting in greater average voltages for the 0.9LiFePO₄.Li_{0.1}Ti_{0.1}(PO₄)_{δ} composite material compared to the LiFePO₄ material at every rate. The low voltage features (between 2.0 and 3.0 V) were also present at all of the discharge rates tested.

### Example 7

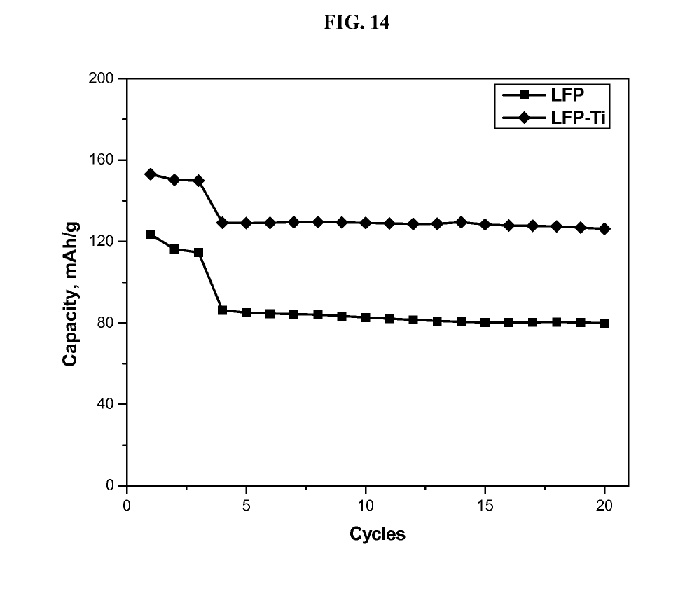

### The discharge capacity retention during cycling of 0.9.LiFePO₄.Li_{0.1}Ti_{0.1}(PO₄)_{δ} and LiFePO₄ (LFP) are shown in FIG. 14. The first 3 cycles were performed at 10 mA/g and the remaining 17 cycles were done at 200 mA/g. The voltage window was 2.0 V to 4.0 V. The 0.9.LiFePO₄.Li_{0.1}Ti_{0.1}(PO₄)_{δ} composite material has a greater capacity than the LiFePO₄ material for every cycle. Both materials have minimal loss in capacity during the first 20 cycles.

### Comparative Example

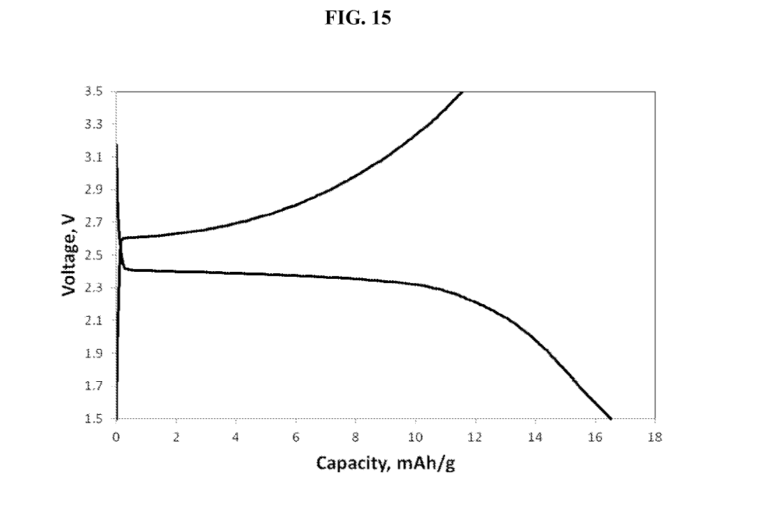

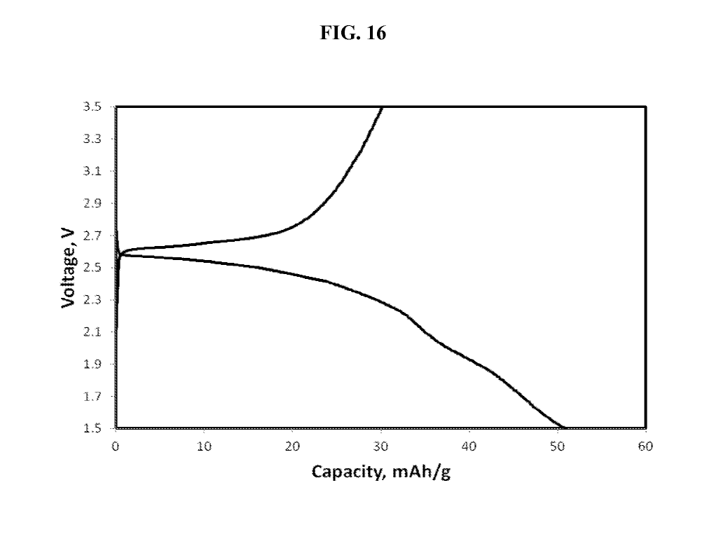

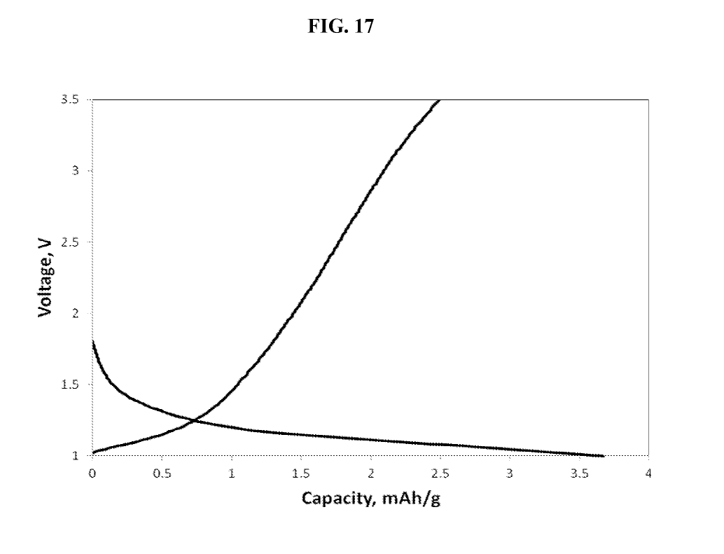

LiTi₂(PO₄)₃, TiP₂O₇, and LiTiO(PO₄) were all synthesized using the same starting precursors and procedure detailed in the “General Procedures” except with different material stoichiometries. The synthesis was performed in air to ensure Ti⁴⁺ in all samples. The charge/discharge curve for LiTi₂(PO₄)₃ at a rate of 1 mA/g is shown in FIG. 15. The charge/discharge curve for TiP₂O₇ at a rate of 1 mA/g is shown in FIG. 16. The charge/discharge curve for LiTiO(PO₄) at a rate of 1 mA/g is shown in FIG. 17.

FIGS. 15, 16, and 17 show that all of the comparative materials exhibit negligible capacity at rates equal to or exceeding 10 mA/g, although the LiTi₂(PO₄)₃ and TiP₂O₇ have electrochemical activity in the range between 2.0 and 3.0 V. However, the poor performance of the pure LiTi₂(PO₄)₃ and TiP₂O₇ compounds signifies that a simple mixing of the compounds with LiFePO₄, each being synthesized individually, will not produce a battery having good capacity. Rather, the above composites [(1-x)LiFePO₄.LiₓTiₓ(PO₄)_{δ}] having the multiple integrated phases, is necessary for the dramatic advantages in cycling performance described above and illustrated by Examples 1-7.

### EQUIVALENTS

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent compositions, apparatuses, and methods within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

While certain embodiments have been illustrated and described, it should be understood that changes and modifications can be made therein in accordance with ordinary skill in the art without departing from the technology in its broader aspects as defined in the following claims.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

What is claimed is:

1. A compound comprising multiple integrated phases of general formula (1-x)LiFePO₄.LiₓTiₓ(PO₄)₅;
wherein:
0<x≦0.3;
1≦δ≦3; and
both the LiFePO₄ and the LiₓTiₓ(PO₄)_{δ} are electrochemically active.

2. The compound of claim 1, wherein the general formula is 0.985.LiFePO₄Li_{0.015}Ti_{0.015}(PO₄)_{δ}.

3. The compound of claim 1, wherein the general formula is 0.95.LiFePO₄Li_{0.05}Ti_{0.05}(PO₄)_{δ}.

4. The compound of claim 1, wherein the general formula is 0.9.LiFePO₄.Li_{0.1}Ti_{0.1}(PO₄)_{δ}.

5. A composition comprising the compound of claim 1 and a binder, wherein: 0<x≦0.1.

6. The composition of claim 5, wherein the binder comprises poly(acrylonitrile), poly(vinylidene fluoride), polyvinyl alcohol, polyethylene, polystyrene, polyethylene oxide, polytetrafluoroethylene, polyimide, styrene butadiene rubber, poly(acrylonitrile), poly(vinylidene fluoride), polyvinyl alcohol, polyethylene, polystyrene, polyethylene oxide, polytetrafluoroethylene, polyimide, styrene butadiene rubber, carboxy methyl cellulose, gelatine, a copolymer of any two or more such polymers, or a blend of any two or more such polymers.

7. An electrode comprising:
a compound of general formula (1-x)LiFePO₄.LiₓTiₓ(PO₄)_{δ}, wherein: 0<x≦0.3 and 1≦δ≦3;
a binder;
and a current collector.

8. The electrode of claim 7, wherein the binder comprises poly(acrylonitrile), poly(vinylidene fluoride), polyvinyl alcohol, polyethylene, polystyrene, polyethylene oxide, polytetrafluoroethylene, polyimide, styrene butadiene rubber, poly(acrylonitrile), poly(vinylidene fluoride), polyvinyl alcohol, polyethylene, polystyrene, polyethylene oxide, polytetrafluoroethylene, polyimide, styrene butadiene rubber, carboxy methyl cellulose, gelatine, a copolymer of any two or more such polymers, or a blend of any two or more such polymers.

9. The electrode of claim 7, wherein the current collector comprises carbon paper, aluminum, nickel, platinum, palladium, gold, silver, copper, iron, stainless steel, rhodium, manganese, vanadium, titanium, or tungsten.

10. The electrode of claim 7 further comprising a conductive filler.

11. The electrode of claim 10, wherein the conductive filler comprises carbon nanotubes, fullerenes, carbon black, graphite, or graphene.

12. A process of preparing a compound comprising multiple integrated phases of general formula (1-x)LiFePO₄.LiₓTiₓ(PO₄)_{δ}, wherein: 0<x≦0.3 and 1≦δ≦3; the method comprising:
milling a lithium source, an iron source, a titanium source, and a phosphate source at a molar ratio of 1:1-x:x:1, respectively, in a suitable suspending medium to form a mixture; and
pyrolyzing the mixture to form the compound of general formula (1-x)LiFePO₄.LiₓTiₓ(PO₄)_{δ}.

13. The process of claim 12, wherein the lithium source comprises lithium carbonate, lithium hydroxide, lithium nitrate, lithium sulfate, lithium acetate, lithium dihydrogen phosphate, or lithium oxalate.

14. The process of claim 12, wherein the iron source comprises iron oxalate dihydrate, iron nitrate, iron sulfate, iron acetate, iron carbonate, iron oxide, or iron phosphate.

15. The process of claim 12, wherein the phosphate source comprises ammonium dihydrogen phosphate, diammonium hydrogen phosphate, ammonium phosphate, lithium dihydrogen phosphate, or phosphoric acid.

16. The process of claim 12, wherein the titanium source comprises titanium oxysulfate, titanium sulfate, titanium chloride, or titanium oxide.

17. The process of claim 12, wherein the lithium source comprises lithium carbonate; the iron source comprises iron oxalate dihydrate; the titanium source comprises titanium oxysulfate; and the phosphate source comprises ammonium dihydrogen phosphate.

18. The process of claim 12, wherein the LiₓTiₓ(PO₄)_{δ} portion is present as nanometer size domains within the LiFePO₄ which is 90 mol % or more of the compound.
